(19) United States
(12) Patent Application Publication
(10) Pub. No.: US 2023/0152259 A1
(43) Pub. Date: May 18, 2023

(54) CALORIMETER FOR IN OPERANDO MEASURING OF THE OVERALL HEAT RELEASED BY A BATTERY CELL

(71) Applicants: FAURECIA SYSTEMES D'ECHAPPEMENT, Nanterre (FR); COLLEGE DE FRANCE, Paris (FR)

(72) Inventors: Selma BEN SAAD, Montbéliard (FR); Jean-Marie TARASCON, Paris (FR); Laura ALBERO BLANQUER, Paris (FR); HUANG Jiaqiang, Paris (FR)

(21) Appl. No.: 17/916,158

(22) PCT Filed: Apr. 3, 2020
(86) PCT No.: PCT/IB2020/000303

§ 371 Date: Sep. 30, 2022

(51) Int. Cl. G01N 25/18; H02J 7/00

(52) U.S. Cl. CPC G01N 25/18; H02J 7/007194

(57) ABSTRACT

A device is provided that measures an overall generated heat flow rate released by a battery cell The device comprises
an electrical power source for charging and discharging the battery,
an internal temperature sensor placed inside the battery,
a surface temperature sensor placed on the surface of the battery cell, and
an ambient temperature sensor placed in the ambient environment.

The device also includes a memory that records the temperatures, and
a processor.

The processor computes characteristic thermal attributes of the battery cell based on a predetermined thermal equivalent circuit of the battery, using temperatures recorded over a predetermined calibration time period, during which the battery is subjected to current emitted by the electrical power source.

The processor then computes the heat flow rate generated by the battery cell towards its ambient environment from a set of recorded temperatures and the thermal attributes of the battery cell.

### CROSS-REFERENCE TO RELATED APPLICATIONS

This application is the US national phase of PCT/IB2020/000303 in, which was filed on Apr. 3, 2020.

### FIELD OF THE DISCLOSURE

The disclosure relates to the field of batteries, and more particularly the field of devices used to measure the overall heat flow rate released by the battery.

### BACKGROUND

With batteries being increasingly used in both the transport and power sectors, there exists a need to increase their reliability and performance. Considering how the heat generated by a battery cell affects the nature, kinetics, and dynamics of the interfaces that govern the battery cell lifetime factors, it is known to use thermal management battery systems (TBMS) for heating or cooling the battery in order to obtain the desired temperature conditions.

Presently, thermal management systems rely on an estimation of the internal temperature within the battery and trigger a heating or cooling system once a fixed temperature threshold is reached. However, such an approach does not consider the interplay dynamics between temperature and heat which are crucial to improve the safety of batteries. Therefore, in order to rationalize the thermal management system and algorithms, heat, heat flow and temperature should be measured simultaneously.

Measuring the heat flow rate generated by a battery cell is usually done by using conventional calorimeters. However, conventional calorimeters have several drawbacks, such as the mass and size of the apparatus itself, their cost, but first and foremost the fact that they can merely measure the dissipation heat flow rate of the battery cells towards their environment under isothermal conditions. This prevents from accessing the heat capacity of the battery and the capacitive heat flow rate, which can be of paramount importance for designing better battery management systems (BMS). While this information may be ignored at relatively slow cycling of the battery, it becomes critical when charging the battery at fast rates, as will be demonstrated below. In the present context in which allowing fast cycling under safe conditions is becoming a critical aspect of the batteries, it is of paramount importance to be able to monitor the overall heat accurately under real working conditions.

It is known to create an equivalent thermal circuit model to access some the heat capacity of the battery (Cp) and to estimate an internal temperature of the battery cell. Such an equivalent thermal circuit model is for instance known from “Thermal modeling of a cylindrical LiFePO4/graphite lithium-ion battery”. Forgez, et al. J. Power Sources 195, 2961-2968 (2010).

However, the method for obtaining these pieces of information requires the use of thermocouples drilled in the battery cells. Not only does such a method render the battery unusable, but metals constitutive of traditional thermocouples tend to interfere with the electrolyte of the batteries, requiring the use of more resistant, and more costly alloys. In addition, thermocouples tend to create electromagnetic interferences, leading to inaccurate measurement of the temperatures and a decrease in battery performance. The accuracy of the measurement made by a thermocouple is also limited as it is dependent on its sensitivity to electrical signals. For example, the nominal measurement resolution of a precise laboratory potentiostat such as Biologic BCS-810, BCS-815 is 40 μV, which give rises to a low temperature resolution of the thermocouple of approximately 1° C.

### SUMMARY

A measurement device is provided that enables a precise monitoring of an overall generated heat flow rate during cycles of a battery, in a way that is non-destructive, accurate, and cost-effective under real working conditions, and to replace a conventional calorimeter.

To that end, the disclosure relates to a measurement device for measuring the overall generated heat flow rate released by a battery cell towards its ambient environment, comprising: an electrical power source for charging and discharging the battery cell; an internal temperature sensor intended to be placed inside the battery cell, and able to sense an internal temperature inside the battery cell; a surface temperature sensor intended to be placed on the surface of the battery cell, and able to sense a surface temperature on the surface of the battery cell; an ambient temperature sensor intended to be placed in an ambient environment outside the battery cell, and able to sense an ambient environment temperature; a memory for recording the internal, surface, and ambient environment temperatures sensed by the internal, surface, and ambient environment temperature sensors; and a processor, wherein the internal temperature sensor is an optical fiber Bragg grating sensor, and wherein the processor computes, during calibration of the measurement device, characteristic thermal attributes of the battery cell based on a predetermined thermal equivalent circuit of the battery cell, using a set of internal, surface, and ambient temperatures recorded over a predetermined calibration time period, named calibration temperatures, during which the battery cell is subjected to current emitted by the electrical power source, the processor being further able to compute overall generated heat flow rate by the battery cell towards its ambient environment from a set of internal, surface, and ambient temperatures and the thermal attributes of the battery cell.

It should be noted that the memory, processor and/or internal, surface, and ambient environment temperature sensors can be part of the same apparatus. For instance, when using an optical interrogator which obtains and converts the optical signal (variation of the wavelength due to the variation of temperature) from the optical fiber Bragg grating sensor into a temperature signal, said interrogator may also record the temperature signal.

The term “ambient” relates to the immediate surrounding area of the battery, that is, usually at a point situated from 1 to 20 cm from the battery's surface.

Thanks to the fact that the measurement device according to the disclosure only necessitates an electrical power source, internal, surface, and ambient environment temperature sensors and a processor, its size and price are much more advantageous compared to a conventional calorimeter. It can therefore advantageously replace a conventional calorimeter.

In addition, the measurement of temperatures inside the battery cell makes it possible access the capacitive heat flow rate and heat capacity of the battery, which are generally ignored in usual isothermal calorimetry but are critical at high charging rates. In other words, the time-resolved overall generated heat flow rate can be obtained whereas a conventional calorimeter can only obtain the dissipation heat flow rate from the battery cell to its ambient environment.

Indeed, owing to the temperature sensing using an optical fiber Bragg sensor, the temperature measurement inside the battery cell can be made in a precise, non-invasive and cheap way.

The small size of optical fiber Bragg grating sensors (less than 200 μm in diameter) enables the non-destructive insertion of the temperature sensing element into the batteries. For instance it can fit in the hollow part of batteries, such as 18650-format cylindrical cells, in which a conventional thermocouple, the diameter of which ranges from 1.6 to 6.3 mm, cannot. This makes the operando measurements of internal temperatures feasible.

Moreover, the optical fibers can be made of silicon with a polyamide coating, making them able to sustain the harsh chemical environment within the electrolyte of batteries. An optical fiber Bragg grating sensor also does not generate any electromagnetic interferences as it relies on optical signals. Finally, the temperature resolution of such a temperature sensor is 0.1° C.

Since both the capacitive heat flow rate and dissipation heat flow rate are obtained, the disclosure also gives access to thermodynamic properties (entropy, enthalpy, etc.) pertaining to the battery chemistry together with its parasitic reactions. The disclosure therefore opens the possibility of upgrading the thermal management of battery cells to another level.

Advantageously, the processor is further able to compute the dissipation heat flow rate transmitted by the battery cell to its ambient environment and the capacitive heat flow rate generated within the battery cell.

Owing to this feature, the measurement device allows differentiating between heat flow rate transmitted by the battery cell to its ambient environment and the capacitive heat flow rate remaining inside the battery cell.

In a preferred embodiment, the battery cell comprises a jelly roll comprising a hollow part, and the internal temperature sensor is placed within the hollow part of the jelly roll. Inserting a sensor within said hollow part allows measuring the temperatures within the battery cell without altering the electrodes.

Because the hollow part is naturally made during the winding process of the battery, the insertion of the sensor in it neither increases the cost/complexity of the manufacturing process nor impairs the volumetric energy density of batteries. Besides, the hollow part theoretically holds the highest temperature along the cross section of the jelly roll, which is a hot spot that is interesting to monitor.

In a preferred embodiment, the battery cell has a sensibly circular cross-section, and the surface temperature sensor is placed on a surface of the battery so that the surface temperature sensor and the internal temperature sensor are aligned on a local radius of the circular cross-section.

This helps avoiding deviation in the measurement due to the temperature gradient along the axis of the cell.

Preferably, the surface sensor is also an optical fiber Bragg grating sensor. The numerous advantages described above can therefore also be obtained for the surface temperature measurement.

In a preferred embodiment, the processor determines, based on the set of calibration temperatures, a steady state of the temperatures and a transient state of the temperatures, and assigns the temperatures recorded in the memory to either the steady state or the transient state.

Being able to discern the steady state of the temperatures from the transient state allows for calibration of the device.

In a preferred embodiment, the characteristic thermal attributes include: an internal thermal resistance between the center and the surface of the battery cell, and/or an outside thermal resistance between the surface of the battery cell and the ambient environment, and/or an isobaric heat capacity of the battery cell.

In a preferred embodiment, the processor computes the internal thermal resistance between the center and the surface of the battery cell, and the outside thermal resistance between the surface of the battery cell and the ambient environment using the electrical power delivered to the battery cell by the power source during the calibration period and the set of calibration temperatures assigned to the steady state.

In a preferred embodiment, the processor computes, based on the set of calibration temperatures assigned to the steady state, the internal thermal resistance, the outside thermal resistance and the heat flow rate dissipated from the battery cell to its environment in a steady state.

In a preferred embodiment, the processor computes the product of the cell's mass and the isobaric heat capacity based on the set of calibration temperatures assigned to the transient state, the electrical power delivered to the battery cell by the power source during the calibration period and the heat flow rate dissipated from the battery cell to its environment in a steady state.

The disclosure also relates to a thermal battery management system including a measurement device according to the disclosure and/or to the use of these devices.

Notably, a thermal battery management system equipped with the measurement device according to the disclosure can predict the quantity of overall heat generation accordingly from a single battery cell to a full pack. It may therefore provide not only a more efficient control of the cooling/heating system but will also be able to manage the heat generation.

The disclosure also relates to a method of measuring the heat flow rate released by a battery cell by using the device according to the disclosure and/or positioning the at least internal temperature sensor within the battery cell.

### BRIEF DESCRIPTION OF THE FIGURES

The disclosure will be better understood in view of the following description, referring to the annexed Figures in which:

FIG. 1 is a schematic view of a battery cell and a measurement device according to the disclosure;

FIG. 2 is a cut-out view in perspective of the battery cell of FIG. 1 in which an internal temperature sensor of the measurement device according to the disclosure is inserted;

FIG. 3 is a schematic view of an equivalent thermal circuit for the battery of FIG. 1;

FIG. 4 is a graph showing the dissipation heat flow rate emitted by a coin battery cell to its environment as measured by a conventional calorimeter and the dissipation heat flow rate emitted by the battery cell of FIG. 1 as measured by the measurement device according to the disclosure;

FIG. 5 is a graph showing the waste heat and lost electrical work emitted by a coin battery cell to its environment as measured by a conventional calorimeter and the waste heat and lost electrical work emitted by the battery cell of FIG. 1 as measured by the measurement device according to the disclosure;

FIG. 6 is a series of graphs showing the rate of overall generated heat flow rate by the battery cell and the heat flow rate dissipated by battery cell of FIG. 1 over time at different C-rates as recorded by the measurement device according to the disclosure.

### DETAILED DESCRIPTION

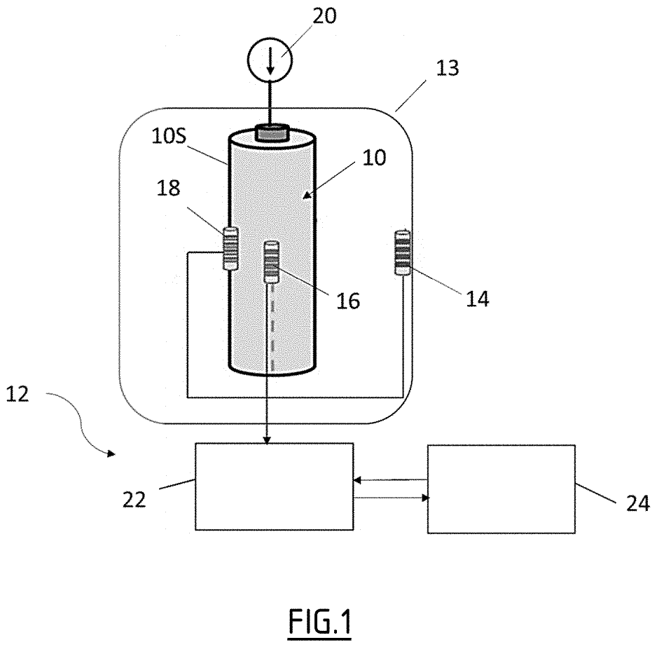

A battery cell 10 and a measurement device 12, or calorimeter 12, according to the disclosure are shown on FIG. 1.

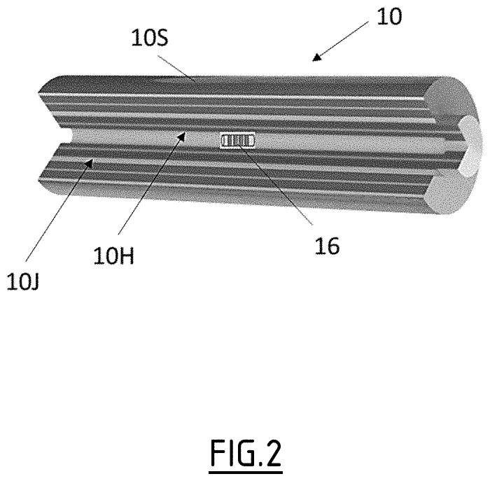

Battery cell 10, shown on FIG. 2, is for example a commercial Na-ion 18650 battery cell which comprises a circular cross-section and a central hollow section 10H within a jelly roll 10J. The jelly roll 10J itself comprises the positive electrode and negative electrode and a plurality of separators. Obviously, other formats of the battery cells such as pouch, prismatic, and coin cells can be used, as well as other electrode and electrolyte compositions.

Preferably, calorimeter 12 is set in a temperature-controllable environment within a cabinet 13 (which can be a temperature-controlled oven). The purpose of the cabinet 13 is to provide a standard thermal environment for the measurements.

Calorimeter 12 comprises an ambient temperature sensor 14 intended to sense and measure the ambient temperature T_{Ambient} of the environment surrounding the battery cell 10. Here, the ambient temperature sensor 14 is placed within the cabinet 13. To be more precise, said ambient temperature sensor 14 is placed on the cabinet wall at different sides inside the cabinet 13.

Preferably, the ambient temperature sensor 14 is an optical Fiber Bragg grating sensors, which will be from now on designated as “FBGs”. Said FBG will be referred to as “ambient FBGs” 14. It shall be noted that in other, less efficient embodiments of the disclosure, other types of sensors may be used to measure the ambient temperature, for example a conventional thermocouple or even a thermometer.

Calorimeter 12 also comprises a temperature sensor 16 intended to sense and measure an internal temperature T_{Internal} inside the battery cell. Internal temperature sensor 16 is preferably placed inside the hollow section 10H of the jelly roll. Internal temperature sensor 16 is an optical Fiber Bragg grating sensors, which will be from now on designated as internal FBG 16.

Calorimeter 12 also comprises a temperature sensor 18 intended to sense and measure the surface temperature T_{Surface} of the battery cell. Here, the surface temperature 18 sensor is placed on the radial surface 10S of the battery so that the surface temperature sensor 18 and the internal temperature sensor 16 are aligned on a local radius of the circular cross-section, as shown on FIG. 1.

Calorimeter 12 also comprises an electrical power source 20 for charging/discharging the battery 10. Said source may be a potentiostat able to generate an alternate galvanostatic pulse at a medium frequency such as 2 Hz.

Calorimeter 12 also comprises a memory 22 for recording the temperatures sensed by the temperature sensors 14, 16, 18. Such a memory 22 can be an external flash disk, a hard disk, a flash memory, etc. or any type of data recording device, or be part of the same device as the temperature sensors. For instance, when using an optical interrogator which obtains and converts the optical signal (variation of the wavelength due to the variation of temperature) from the optical fiber Bragg grating sensor into a temperature signal, said interrogator may also record the temperature signal.

Calorimeter 12 also comprises a processor 24 that computes, during calibration of the device, characteristic thermal attributes of the battery cell 10 using a set of internal, surface and ambient temperatures recorded over a predetermined calibration time period, named calibration temperatures, during which the battery is subjected to current emitted by the electrical power source 20, as will be explained below.

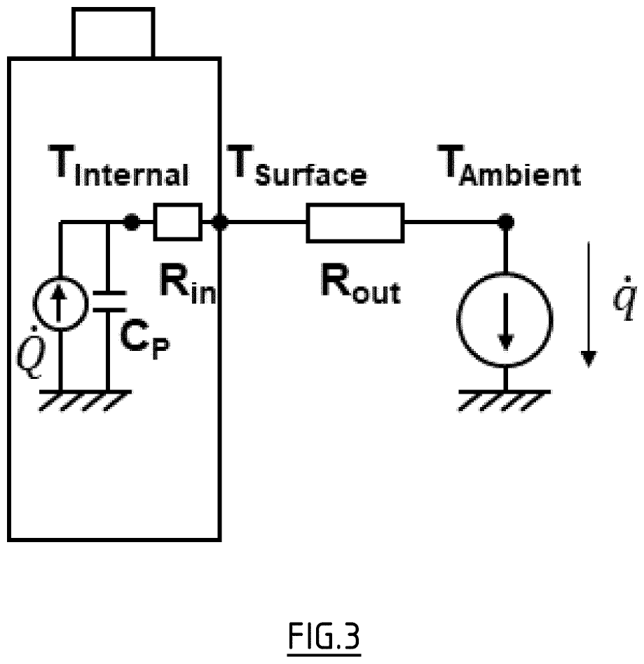

Here the characteristic thermal attributes computed by processor 24 are based on a predetermined thermal equivalent circuit of the battery, an example of which is shown on FIG. 3.

In a preferred embodiment of the disclosure, said thermal equivalent circuit is based on the partition of the overall generated heat flow rate, between the capacitive heat flow rate remaining within the battery and the dissipation heat flow rate dissipated from the battery to its ambient environment, as expressed in the equation below:

$$\dot{Q} = {MC}_{p} \frac{dT}{dt} + \dot{q} \qquad [ Math 1 ]$$

where \dot{Q} is the overall generated heat flow rate, \dot{q} is the dissipation heat flow rate from the battery cell to its ambient environment, i.e. the dissipated heat flow rate, M is the mass of the battery cell, C_{P} is the specific heat capacity of the battery cell at constant pressure, i.e. isobaric heat capacity, T is the temperature of the battery cell (here the volume-weighted average temperature is used), and t is time. \dot{Q} and \dot{q} are defined as positive if heat is released by the battery cell.

a. The thermal equivalent circuit is also based on the assumption that the internal temperature, T_{Internal} and the surface temperature T_{Surface} of the battery are uniform, respectively, that the internal heat transfer resistances within the battery can be combined into a single one hereby named Rᵢₙ and that similarly, the external heat resistances between the surface of the battery and its ambient environment are combined into a single one hereby named Rₒᵤₜ.

Based on the thermal equivalent circuit, the heat flow rate \dot{q} follows the two following equations:

$$\dot{q} = \frac{{T}_{Surface} - {T}_{Ambient}}{{R}_{out}} or \dot{q} = \frac{{T}_{Internal} - {T}_{Surface}}{{R}_{in}} \qquad [ Math 2 ]$$

Considering this choice of thermal equivalent circuit, in this particular embodiment of the disclosure, the characteristics thermal attributes of the battery computed by the processor during calibration of calorimeter 12 are the internal thermal resistance Rᵢₙ between the center and the surface of the battery cell, the outside thermal resistance Rₒᵤₜ between the surface of the battery cell and the ambient environment, and the product MCₚ of the cell's mass M and isobaric heat capacity Cₚ.

In order to calibrate these parameters, an alternate galvanostatic pulse of 2 Hz is applied by the electrical power source 20 to the battery cell and the evolution of potential is recorded over time by memory 20. The total generated heat flow rate is known from the equation:

\dot{Q}=P=ϕ_{cycle}IV [Math 3]

where P is the electrical power, with I and V being the current and voltage, respectively.

Then, processor 24 determines, based on the set of calibration temperatures, a steady state of the temperatures and a transient state of the temperatures, and assigns the temperatures recorded in the memory 22 to either the steady state or the transient state. The steady state is reached when all the generated heat is dissipated, i.e. when the total generated heat flow rate \dot{Q} is equal to the dissipation heat flow rate \dot{q}, because the temperatures become stable.

Using the set of calibration temperatures assigned to the steady state, hereby named steady temperatures T_{SInternal}, T_{SSurface} and T_{SAmbient}, and the electrical power delivered to the battery cell by the power source 20, processor 24 computes the internal thermal resistance and the outside thermal resistance Rₒᵤₜ.

In other words, knowing the total generated heat flow rate \dot{Q} linked to the electrical power delivered to the battery cell by the power source 20 and the steady temperatures T_{SInternal}, T_{SSurface} and T_{SAmbient}, measured by the internal FBG 16, the surface FBG 18 and the ambient FBG 20, processor 24 can compute Rₒᵤₜ and Rᵢₙ using the equations:

$$\dot{q} = \frac{{T}_{SSurface} - {T}_{SAmbient}}{{R}_{out}} or \dot{q} = \frac{{T}_{SInternal} - {T}_{SSurface}}{{R}_{in}} \qquad [ Math 4 ]$$

Having computed the characteristic thermal attributes Rₒᵤₜ, Rᵢₙ based on the set of calibration temperatures assigned to the steady state T_{Sinternal}, T_{SSurface} and T_{SAmbient}, processor 24 computes the dissipation heat flow rate \dot{q} dissipated from the battery cell to its environment in a steady state.

Subsequently, processor 24 obtains the factor MCₚ based on the set of calibration temperatures assigned to the transient state, the electrical power delivered to the battery cell by the power source 20 during the calibration period, which is related to the overall generated heat flow rate \dot{Q} as mentioned earlier and the dissipation heat flow rate \dot{q} dissipated from the battery cell to its environment.

More particularly, the factor MCₚ is obtained using the equation:

$$\dot{Q} - \dot{q} = {MC}_{p} \frac{dT}{dt} \qquad [ Math 5 ]$$

Here \dot{Q}−\dot{q} are known as described above. Using the recorded temperature assigned to the transient state, which represents the term

$$\frac{dT}{dt} ,$$

the coefficient MCₚ can be obtained a linear fitting performed by processor 24.

After calibration, the characteristic thermal attributes Rₒᵤₜ, Rᵢₙ and Cₚ (here MCₚ) are recorded in memory 20 and can be used for measuring the total heat flow rate generated \dot{Q} by the battery cell towards its ambient environment from a set of internal, surface and ambient temperatures T_{Internal}, T_{Surface} and T_{Ambient}.

In view of the above equation, the dissipation heat flow rate \dot{q} transmitted by the battery cell to its ambient environment can easily be distinguished from the capacitive heat flow rate

$${MC}_{p} \frac{dT}{dt}$$

generated within the battery cell.

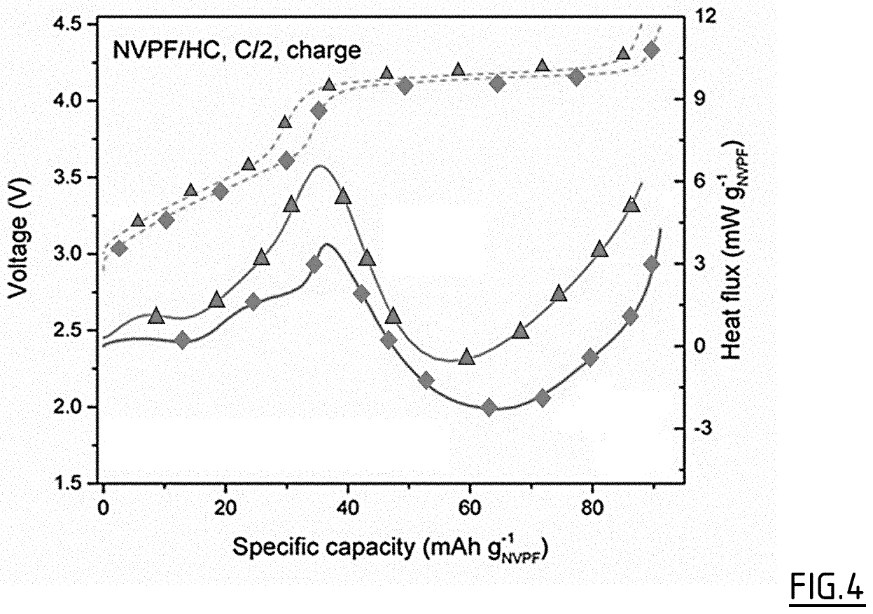

Using the calorimeter 12 according to the disclosure, the dissipation heat flow rate \dot{q} at a charge-discharge rate of C/2 (two-hour discharge) for battery 10 was obtained and compared with the dissipation heat flow rate \dot{q} measured from a conventional isothermal calorimeter for a coin battery cell. The plotted results for the calorimeter according to the disclosure 12 are designated by diamonds and the ones for the conventional calorimeter are designated by triangles on FIG. 4.

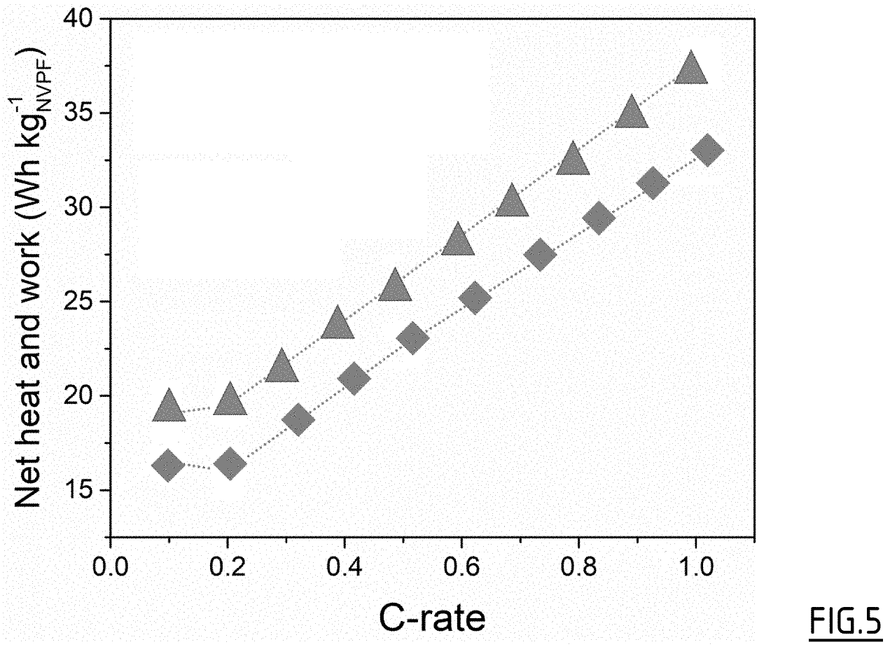

As can be seen on FIG. 4, the shape of the curve obtained for the two calorimeters are similar. The magnitude difference comes from the configurations of the coin battery cell as opposed to the 18650 battery cell (battery 10). To confirm the origin of said difference, the lost electrical work (ϕ_{cycle}IVdt) and waste heat (ϕ_{cycle}\dot{q}dt) per cycle in both configurations and at different C-rates were also compared, as shown on FIG. 5 where the plotted results for the calorimeter according to the disclosure 12 are designated by diamonds and the ones for the conventional calorimeter are designated by triangles.

According to the energy balance equation, in a battery, the lost electrical work should be close to the waste heat because the internal energy of the stable battery does not change after cycles as supported by the results in both configurations. This agreement verifies the accuracy of the measurement of dissipation heat flow rate \dot{q} made by the calorimeter 12 according to the disclosure, as the lost electrical work is accurately acquired by the potentiostat.

In addition, the values of dissipated heat flow rate for the 18650 battery cell measured by the calorimeter 12 according to the disclosure is lower than the one measured using a conventional calorimeter for the coin battery cell at all C-rates as shown on FIG. 5, thus confirming that the difference of magnitude results from the difference in configurations (coin battery cell vs. 18650 battery cell) rather than the heat flow rate measurements.

Therefore, it is proven that the calorimeter 12 according to the disclosure provides equal results as a conventional calorimeter to quantify the heat flow rate \dot{q}

exchanged between the battery cell and the ambient environment. However, the calorimeter 12 according to the disclosure is cheaper, less cumbersome to use. In addition, as explained above, it gives access to the capacitive heat flow rate

$${MC}_{p} \frac{dT}{dt} .$$

The relevance of obtaining the capacitive heat flow rate

$${MC}_{p} \frac{dT}{dt}$$

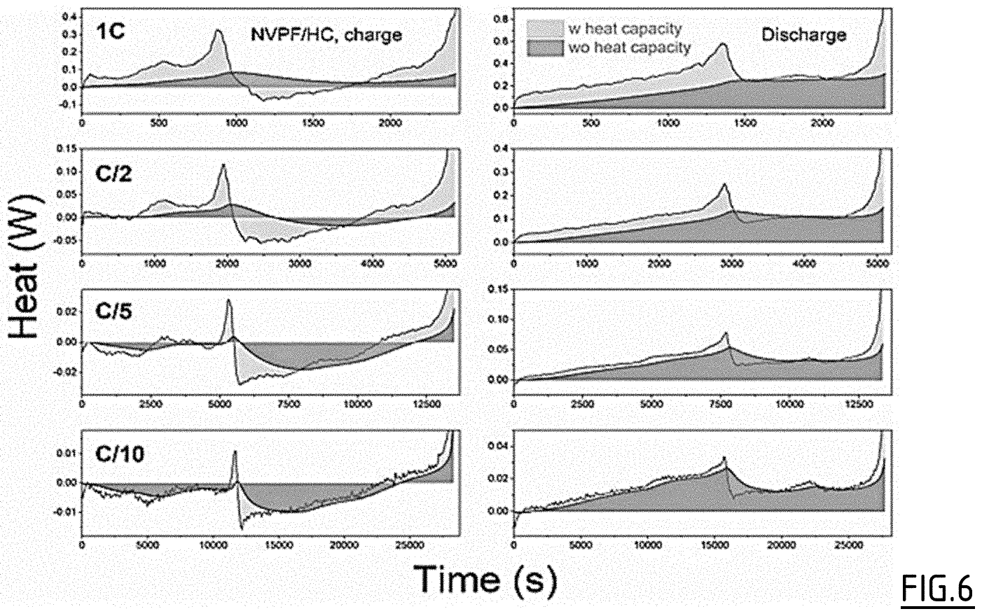

is illustrated by FIG. 6. For four different C-rates, a comparison between the total heat flow rate generated by the battery cell \dot{Q} and the dissipation heat flow rate \dot{q} is made. It shows an increasing difference with C-rates.

For example, \dot{Q} is similar to \dot{q} at C/10 but markedly larger than \dot{q} at 1 C. Notably, the transient heat flow rate

$${MC}_{p} \frac{dT}{dt}$$

at 1 C (up to 0.9 W) can be of one order of magnitude larger than the one at C/10 (up to 0.07 W).

These results imply that a considerable amount of energy is stored as the internal energy at high rates via the heat capacity Cₚ of the battery cell. Interestingly, it conflicts with the general belief that the capacitive heat flow rate

$${MC}_{p} \frac{dT}{dt}$$

is negligible because of the isothermal and thermally conductive conditions. However, the results obtained thanks to the calorimeter according to the disclosure 12 shows that this belief may not hold true at high C-rates and shows the importance of the benefits of the disclosure.

The disclosure is not limited to the presented embodiments and other embodiments will clearly appear to the person of ordinary skill in the art.

For instance, other temperature sensors may be used, a multiplicity of processors may be used in order to perform the computing required by the measurement device, and other formats of the battery cells such as pouch, prismatic, and coin cells can be used.

### LIST OF REFERENCES

10: Battery
10J: Jelly roll of the battery
10H: Hollow part of the battery
10S: Battery surface
12: Calorimeter
13: Cabinet
14: Ambient temperature sensor
16: Internal temperature sensor
18: Surface temperature sensor
20: Electrical power source
22: Memory
24: Processor
Cₚ: specific heat capacity of the battery cell at constant pressure
M: mass of the battery cell
\dot{Q}: total heat flow rate released by the battery
\dot{q}: dissipation heat flow rate Rᵢₙ: internal thermal resistance
Rₒᵤₜ: external thermal resistance
T_{Internal}: internal temperature of the battery cell
T_{Surface}: surface temperature of the battery cell
T_{Ambient}: ambient environment temperature
T_{SInternal}: steady internal temperature of the battery cell
T_{SSurface}: steady surface temperature of the battery cell
T_{SAmbient}: steady ambient environment temperature

1. A measurement device for measuring an overall generated heat flow rate released by a battery cell towards its ambient environment, comprising:
an electrical power source for charging and discharging the battery cell;
an internal temperature sensor, intended to be placed inside the battery cell, and able to sense an internal temperature inside the battery cell;
a surface temperature sensor, intended to be placed on a surface of the battery cell, and able to sense a surface temperature on the surface of the battery cell;
an ambient temperature sensor, intended to be placed in an ambient environment outside the battery cell, and able to sense an ambient environment temperature;
a memory for recording the internal, surface, and ambient environment temperatures sensed by the temperature sensors; and
a processor, wherein the internal temperature sensor, is an optical fiber Bragg grating sensor, and
wherein the processor computes, during calibration of the measurement device, characteristic thermal attributes of the battery cell based on a predetermined thermal equivalent circuit of the battery cell, using a set of internal surface and ambient environment temperatures recorded over a predetermined calibration time period, named calibration temperatures, during which the battery cell is subjected to current emitted by the electrical power source, the processor being further able to compute the overall generated heat flow rate generated by the battery cell towards its ambient environment from a set of internal, surface, and ambient environment temperatures and the thermal attributes of the battery cell.

2. The measurement device according claim 1, wherein the processor is further able to compute a dissipation heat flow rate transmitted by the battery cell to its ambient environment and a capacitive heat flow rate generated within the battery cell.

3. The measurement device according to claim 1, wherein the battery cell comprises a jelly roll comprising a hollow part, and wherein the internal temperature sensor is placed within the hollow part of the jelly roll.

4. The measurement device according claim 3, wherein the battery cell has a sensibly circular cross-section, and wherein the surface temperature sensor is placed on a surface of the battery cell so that the surface temperature sensor and the internal temperature sensor are aligned on a local radius of the circular cross-section.

5. The measurement device according to claim 1, wherein the surface temperature sensor is an optical fiber Bragg grating sensor.

6. The measurement device according to claim 1, wherein the processor determines, based on a set of the calibration temperatures, a steady state of the internal, surface, and ambient environment temperatures and a transient state of the internal, surface, and ambient environment temperatures, and assigns the internal, surface, and ambient environment temperatures recorded in the memory to either the steady state or the transient state.

7. The measurement device according to claim 1, wherein the characteristic thermal attributes include:
an internal thermal resistance between a center and the surface of the battery cell, and/or
an outside thermal resistance between the surface of the battery cell and the ambient environment, and/or
an isobaric heat capacity of the battery cell.

8. The measurement device according to claim 6, wherein the characteristic thermal attributes include:
an internal thermal resistance between a center and the surface of the battery cell, and/or
an outside thermal resistance between the surface of the battery cell and the ambient environment, and/or
an isobaric heat capacity of the battery cell; and wherein the processor computes the internal thermal resistance between the center and the surface of the battery cell, and the outside thermal resistance between the surface of the battery cell and the ambient environment using electrical power delivered to the battery cell by the electrical power source during the predetermined calibration time period and the set of the calibration temperatures assigned to the steady state.

9. The measurement device according to claim 6, wherein the processor computes, based on the set of the calibration temperatures assigned to the steady state, an
internal thermal resistance, an outside thermal resistance and a heat flow rate dissipated from the battery cell to its environment in a steady state.

10. The measurement device according to claim 6, wherein the processor computes a product of a mass and an isobaric heat capacity of the battery cell based on the set of the calibration temperatures assigned to the transient state, electrical power delivered to the battery cell by the electrical power source during the predetermined calibration time period and a heat flow rate dissipated from the battery cell to its environment.

11. A thermal battery management system, including the measurement device according to claim 1.
